(19) United States
(12) Patent Application Publication
(10) Pub. No.: US 2007/0017314 A1
(43) Pub. Date: Jan. 25, 2007

(54) Gear and gear mechanism

(75) Inventor: Hidehisa Konishi, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/486,875

(22) Filed: Jul. 14, 2006

(30) Foreign Application Priority Data
Jul. 21, 2005 (JP) 2005-211841

(51) Int. Cl. F16H 55/00

(52) U.S. Cl. 74/462

(57) ABSTRACT

A gear includes a gear main body and a plurality of teeth projecting on the outer circumferential surface of the gear main body. Each tooth has a plurality of crowned portions formed by arcuate bulges along a tooth trace direction. In the case of constructing a gear mechanism using this gear, mating gears are respectively engaged with the respective crowned portions.

### BACKGROUND OF THE INVENTION

1. Field of the Invention.

The present invention relates to a gear used to transmit a driving force and a gear mechanism using such a gear.

2. Description of the Related Art.

Gears are very general means for transmitting a driving force, and it is no exaggeration to say that gears are used in every driving-force transmitting mechanism. Every gear has a basic construction comprised of a round gear main body and a plurality of identically-shaped teeth projecting at even intervals in circumferential direction from the outer circumferential surface of the gear main body. Gears are classified into various kinds such as spur gears whose tooth traces (directions of teeth intersecting with the circumferential direction of gears) are in parallel with central-axis directions and helical gears whose tooth traces are inclined with respect to center axes, depending on how teeth are formed, but are identical as long as the basic construction is concerned.

In gears having thick gear main bodies, tooth traces are accordingly longer. In the case of engaging such teeth having a long tooth trace with the teeth of another gear, it is difficult to constantly properly engage these teeth so as not to change an engaged state due to the presence of a manufacturing error and other reasons.

In order to solve such a problem, crowning is applied to teeth in some cases. Crowning is a processing for forming a tooth with arcuate bulges projecting in circumferential direction at a central part with respect to a tooth trace direction. This processing is carried out by gradually reducing the thickness of the tooth from the central part of the tooth toward the opposite ends along the tooth trace direction.

By applying the crowning as above to teeth, engaged positions are not considerably displaced from the arched central parts with these teeth engaged with those of another gear even if the teeth have a small manufacturing error. Thus, forces of tooth flanks of one gear can be securely transmitted to the teeth of the mating gear on the best condition.

In a gear mechanism constructed by combining a plurality of gears, there are cases where a driving force is transmitted from one drive gear having a long tooth trace to a plurality of driven gears and a plurality of driven gears cannot be engaged at the same positions of the drive gear with respect to a tooth trace direction due to a layout restriction of the gear mechanism. In such a case, the mating driven gears are engaged with the drive gear at different positions even if crowning is applied to the drive gear. Thus, it is not possible to engage the teeth of all the driven gears with the central part of the drive gear with respect to the tooth trace direction. Therefore, there arises a problem that the driving force of the crowned drive gear cannot be equally and efficiently transmitted to all the driven gears.

Such gear mechanisms in which a driving force is transmitted from one drive gear having a long tooth trace to a plurality of driven gears are used in copiers, facsimile apparatuses and like image forming apparatuses frequently required to synchronize the driving of parts in apparatuses.

### SUMMARY OF THE INVENTION

An object of the present invention is to enable one gear to be engaged with any of a plurality of mating gears on the best condition in such a gear mechanism that one gear is engaged with a plurality of mating gears.

One aspect of the present invention is directed to a gear, comprising a gear main body; and a plurality of teeth projecting on the outer circumferential surface of the gear main body, each tooth including a plurality of crowned portions formed by arcuate bulges along a tooth trace direction.

Another aspect of the present invention is directed to a gear mechanism, comprising a first gear; and a plurality of mating gears engageable with the first gear, wherein the first gear includes a gear main body; and a plurality of teeth projecting on the outer circumferential surface of the gear main body, each tooth having a plurality of crowned portions formed by arcuate bulges along a tooth trace direction.

With these constructions, upon engaging a plurality of mating gears with the gear formed with a plurality of crowned portions at each tooth (hereinafter, “crowned gear”), any of the mating gears can be engaged at the middle positions of the respective crowned portions by engaging the teeth of the plurality of mating gears with the respective crowned portions of the crowned gear. Thus, the crowned gear can be engaged with any of the mating gears on the best condition, with the result that the indiscriminate and efficient transmission of a driving force to all the mating gears can be realized.

### BRIEF DESCRIPTION OF THE DRAWINGS

FIGS. 1A and 1B are a perspective view and an end surface view showing one embodiment of a crowned gear according to the invention,

FIG. 2 is a partial perspective view of the crowned gear shown in FIGS. 1A and 1B,

FIG. 3 is a perspective view shown in a direction A of FIG. 2,

FIG. 4 is a perspective view showing one embodiment of a gear mechanism employing a crowned gear, and

FIGS. 5A and 5B are perspective views showing another embodiment of a gear mechanism employing a crowned gear, wherein FIG. 5A is an exploded perspective view and FIG. 5B is a perspective view showing the assembled gear mechanism.

### DETAILED DESCRIPTION OF THE PREFERRED EMBODIMENTS

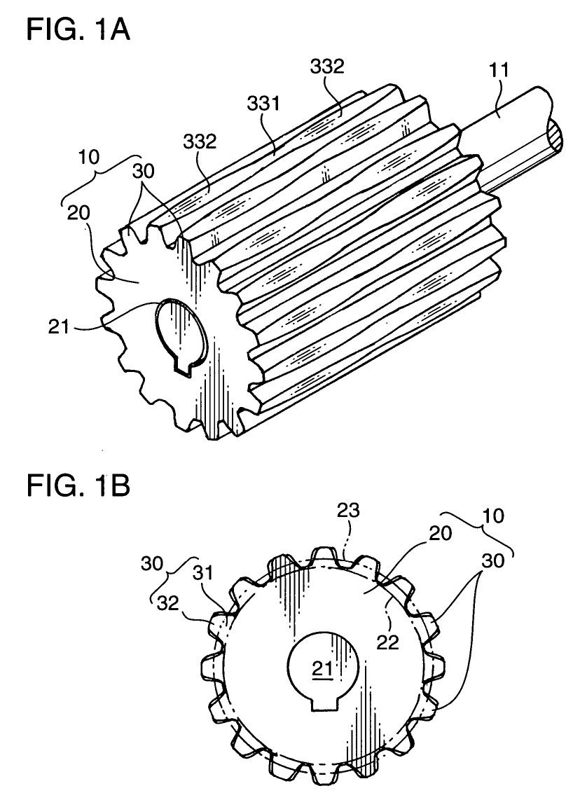

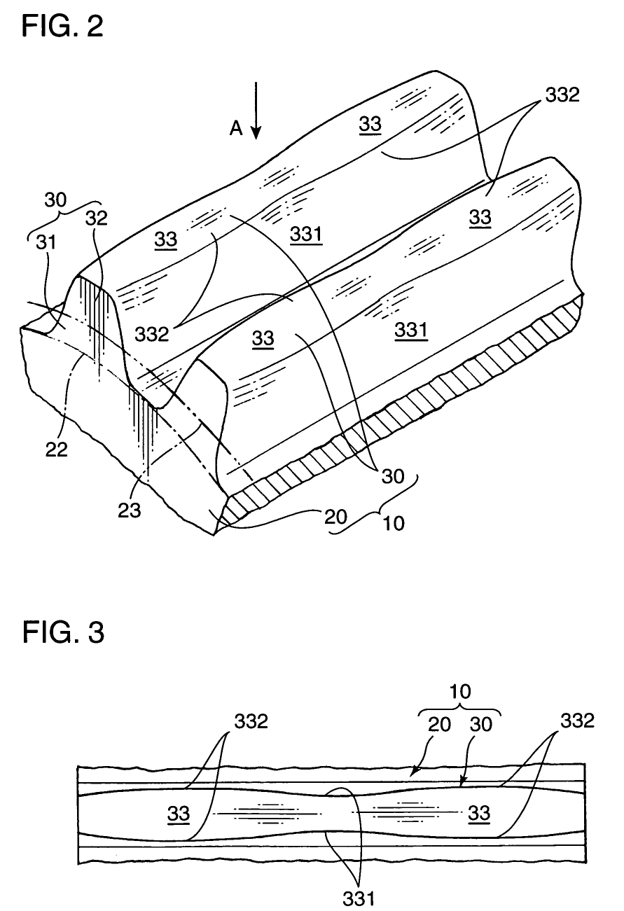

FIGS. 1A and 1B are a perspective view and an end surface view showing one embodiment of a crowned gear according to the invention, FIG. 2 is a partial perspective view of the crowned gear shown in FIGS. 1A and 1B, and FIG. 3 is a perspective view shown in a direction A of FIG. 2. As shown in FIGS. 1A and 1B, a crowned gear 10 is comprised of a cylindrical gear main body 20 formed at its center position with a shaft hole 21 into which a specified drive shaft 11 is concentrically fitted to be integrally rotatable with the gear main body 20, and a plurality crowned teeth 30 projecting radially outward from the outer circumferential surface of the gear main body 20 and arranged at even intervals in circumferential direction. The gear main body 20 is formed inside a so-called root circle 22 shown by chain line in FIGS. 1B and 2, whereas the crowned teeth 30 are formed outside the root circle 22.

The crowned teeth 30 project radially outward from the outer circumferential surface of the gear main body 20 while being tapered and having the same length as the axial length of the gear main body 20. Each of such crowned teeth 30 is comprised of a dedendum portion 31 at the base side and a tip portion 32 at the leading side inside and outside a pitch circle 23 having a larger diameter than the root circle 22 shown by chain double-dashed line in FIGS. 1B and 2. The pitch circle 23 is a friction circle when the gear is regarded as a circle having no teeth (called to be an equivalent friction circle). The crowned teeth 30 are effectively engaged with teeth of a mating gear at positions on this pitch circle 23.

Such crowned teeth 30 are formed to extend along cycloidal curves or involute curves when end surfaces thereof are viewed, whereby forces can be efficiently transmitted.

In this embodiment, the crowned gear 10 used are made of metal. Crowning is applied to the crowned teeth 30 of this gear 10 using a machine tool for manufacturing gears such as a gear hobbing machine or a shaving machine, thereby forming a plurality crowned portions 33 in the longitudinal direction of the crowned teeth 30. In an example shown in FIG. 1A, the crowned portions 33 are formed at one side (left side in FIG. 3) and the other side (right side in FIG. 3) of a center position 331 with respect to the tooth trace direction for one crowned tooth 30.

Each crowned portion 33 is such that middle portions 332 between the ends of the crowned tooth 30 and a middle position 331 arcuately bulge out in opposite directions along circumferential direction as shown in FIG. 3. These bulged portions are mainly formed at the tip portion 32. In other words, the width of the crowned tooth 30 in circumferential direction is narrowest at the middle position 331 and at the opposite ends with respect to the tooth trace direction, and the middle portions 332 between one end and the middle position 331 and between the other end and the middle position 331 bulge out to a largest extent. The formation pattern of such a crowned portion 33 is common to the respective crowned teeth 30.

According to such a crowned gear 10, if two mating gears are engaged with the crowned gear 10, one of the mating gears can be engaged with the middle portions 332 of the crowned portions 33 at one side while the other mating gear can be engaged with the middle portions 332 of the other crowned portions 33 at the other side. Accordingly, either one of the mating gears can be engaged with the crowned gear 10 on the best condition, wherefore a driving force is efficiently and precisely transmitted between the mating gears and the crowned gear 10.

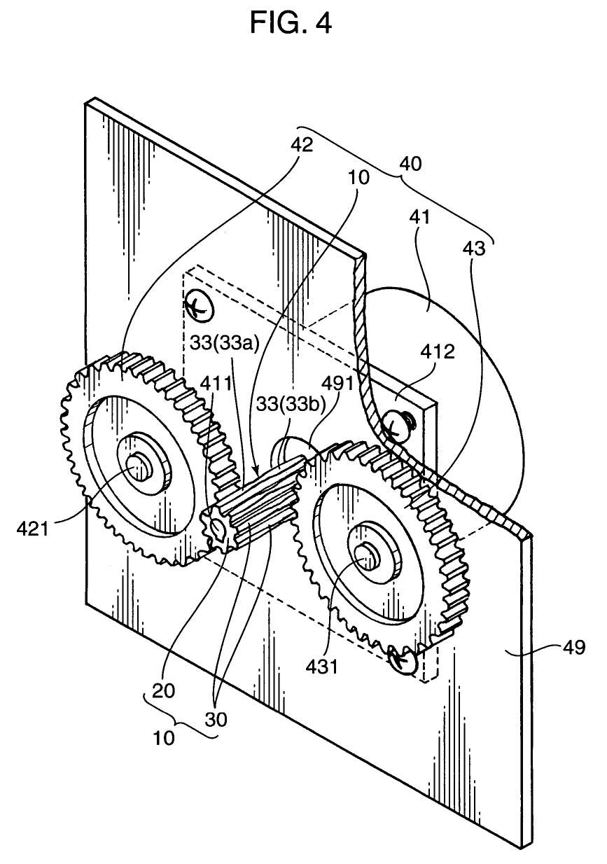

FIG. 4 is a perspective view showing one embodiment of a gear mechanism 40 employing the crowed gear 10. In the gear mechanism 40 of this embodiment, the crowned gear 10 is used as a drive gear (first gear). In other words, the gear mechanism 40 is provided with a drive motor 41, the crowned gear 10 concentrically mounted on a drive shaft 411 of the drive motor 41 in such a manner as to be integrally rotatable, and a first driven gear 42 (second gear) and a second drive gear 43 (third gear) engaged with the crowned gear 10 and having larger diameters than the crowned gear 10.

The drive motor 41 provided with the crowned gear 10 and the first and second driven gears 42, 43 engaged with the crowned gear 10 are both mounted on a specified frame plate 49. Specifically, the drive motor 41 has a rectangular mounting plate 412 integral to a casing at one end surface, and this mounting plate 412 is fixed to the back side of the frame plate 49 in FIG. 4 by means of screws. In this way, the crowned gear 10 integral to the drive shaft 411 projects toward the front side of the frame plate 49 through a through hole 491 formed in the center of the frame plate 49.

The first driven gear 42 is so supported on a first supporting shaft 421 as to be rotatable about the first supporting shaft 421 projecting in parallel with the drive shaft 411 from the front side of the front plate 49 at apposition of the frame plate 49 at the left side of the crowned gear 10 in FIG. 4, and is engaged with the crowned portions 33 (first crowned portions 33a) at the front side (side more distant from the drive motor 41) of the crowned teeth 30 in FIG. 4. Further, the second driven gear 43 is so supported on a second supporting shaft 431 as to be rotatable about the second supporting shaft 431 projecting in parallel with the drive shaft 411 from the front side of the front plate 49 at a position of the frame plate 49 at the right side of the crowned gear 10 in FIG. 4, and is engaged with the crowned portions 33 (second crowned portions 33b) at the back side (side closer to the drive motor 41) of the crowned teeth 30 in FIG. 4.

More specifically, the first driven gear 42 is engaged with the middle portions 332 (see FIG. 2) of the first crowned portions 33a of the crowned teeth 30. The second driven gear 43 is engaged with the middle portions 332 of the second crowned portions 33b. Accordingly, both first and second driven gears 42, 43 are engaged with the crowed teeth 30 of the crowned gear 10 on the best condition, whereby the driving rotation of the crowned gear 10 is efficiently transmitted to the first and second driven gears 42, 43.

Such a gear mechanism 40 can be used as a mechanism, for example, in the case of synchronously rotating a fixing roller and a pressure roller or synchronously rotating a photosensitive drum and a developing device in an image forming apparatus. In the case of employing the gear mechanism 40 as the mechanism for synchronously rotating the fixing roller and the pressure roller, the first driven gear 42 is connected, for example, with the fixing roller directly or via another gear mechanism and the outer circumferential surface of the pressure roller is brought into contact with that of the fixing roller, whereby the pressure roller can be rotated by the fixing roller. In this case, the second driven gear 43 is used as a driving source for another unit.

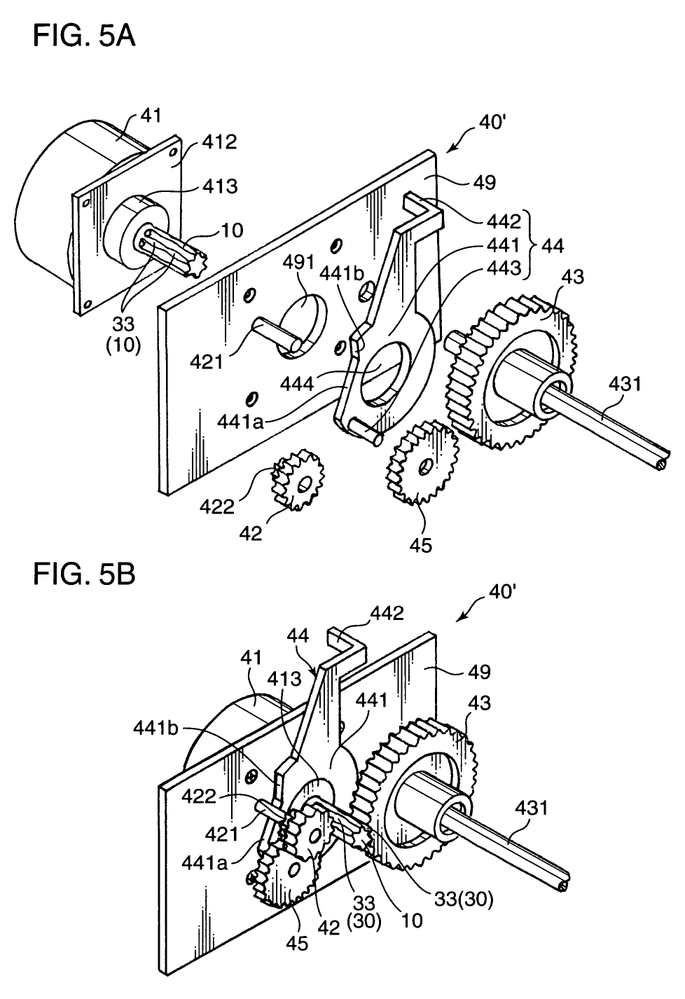

FIGS. 5A and 5B are perspective views showing another embodiment of a gear mechanism 40′ employing the crowned gear 10, wherein FIG. 5A is an exploded perspective view and FIG. 5B is a perspective view showing the assembled gear mechanism 40′. The gear mechanism 40′ of this embodiment is constructed such that the rotation of the crowned gear 10 functioning as a drive gear is transmitted to a first and a second driven gears 42, 43 and a specified member (idle arm 44 to be described later) is operated depending on a rotating direction of the crowned gear 10.

Specifically, the gear mechanism 40′ is similar to the previous-embodiment in being constructed to transmit a driving force to both first and second driven gears 42, 43 mounted on a frame plate 49, but differs therefrom in being additionally provided with the idle arm 44 whose operating direction is reversed depending on the rotating direction of a drive motor 41 and an actuating gear 45 for actuating the idle arm 44.

A bush 413 projecting toward the front side of the frame plate 49 through a through hole 491 with the drive motor 41 mounted on the frame plate 49 is provided on a mounting plate 412 of the drive motor 41. The idle arm 44 is comprised of an arm main body 441 having a half-moon shape, an operable arm 442 projecting upward from the upper end of the arm portion 441, and a projecting shaft 443 projecting from a bottom end position of the arm main body 441 toward a side opposite to the frame plate 49 and adapted to support the actuating gear 45.

A fitting hole 444 fittable to the bush 413 in sliding contact therewith is formed in a middle part of the arm main body 441. This fitting hole 444 is fitted on the bush 413 projecting toward the front side of the frame plate 49 through the through hole 491. This enables the idle arm 44 to be rotated in forward and reverse directions about the bush 413.

The idle arm 44 is dimensioned and shaped as follows. A moment acting in clockwise direction in FIG. 5B about the bush 413 is slightly larger than a moment acting in counterclockwise direction with the actuating gear 45 mounted on the projecting shaft 443 and the idle arm 44 supported on the bush 413.

Further, a small gear 422 concentric with the first driven gear 42 and engaged with the actuating gear 45 is so provided on the back surface (surface facing the frame plate 49) of the first driven gear 42 as to be integrally rotatable. The idle arm 44 is dimensioned such that the actuating gear 45 is engaged with this small gear 422.

According to the gear mechanism 40′ of this embodiment, as shown in FIG. 5B, the first driven gear 42 is engaged with the crowned portions 33 at one side of the crowned teeth 30 of the crowned gear 10 and the second driven gear 43 is engaged with the crowned portions 33 at the other side with the drive motor 41, the first driven gear 42, the second driven gear 43, the idle arm 44 having the actuating gear 45 mounted on the frame plate 49. Thus, the driving rotation of the crowned gear 10 given by driving the drive motor 41 can be efficiently and securely transmitted to both first and second driven gears 42, 43.

With the second driven gear 43 engaged with the crowned portions 33 at the other side, the small gear 422 of the first driven gear 42 is engaged with the actuating gear 45 supported on the projecting shaft 443 of the idle arm 44. Thus, if the first driven gear 42 is rotated in clockwise direction in FIG. 5B about the first supporting shaft 421 via the crowned gear 10 by driving the drive motor 41, this rotation is transmitted to the actuating gear 45 via the small gear 422. Upon receiving this rotating force, the actuating gear 45 is rotated in counterclockwise direction about the projecting shaft 443.

At this time, since the teeth of the small gear 422 press those of the actuating gear 45 to the left in FIG. 5B, a moment acts on the idle arm 44 in clockwise direction about the bush 413. However, the idle arm 44 is not rotated in clockwise direction about the bush 413 since an oblique side 441a of the arm main body 441 is in contact with the first supporting shaft 421 of the small gear 422.

Contrary to this, when the first driven gear 42 is rotated in counterclockwise direction about the first supporting shaft 421 by driving the drive motor 41 in reverse direction, this rotation is similarly transmitted to the actuating gear 45 via the small gear 422, whereby the actuating gear 45 is rotated in clockwise direction about the projecting shaft 443. At this time, since the teeth of the small gear 422 press those of the actuating gear 45 to the right in FIG. 5B, a moment acts on the idle arm 44 in counterclockwise direction about the bush 413. In this case, since a vertical side 441b of the arm main body 441 is distanced from the first supporting shaft 421 of the small gear 422, the idle arm 44 is rotated in counterclockwise direction about the bush 413 until this vertical side 441b comes into contact with the first supporting shaft 421.

By this rotation, the idle arm 44 is rotated by a specified angle about the bush 413, and this amount of rotation is kept constant while the first driven gear 42 is rotated in counterclockwise direction. On the other hand, when the first driven gear 42 starts being rotated in clockwise direction, the idle arm 44 returns to its initial posture.

Accordingly, the operable arm 442 can be utilized to perform a specific action depending on the rotating direction of the drive motor 41. The gear mechanism 40′ of this embodiment is utilized as a mechanism for stopping the driving of a developing device in a tandem color image forming apparatus.

As described in detail above, each crowned tooth 30 is formed with a plurality of crowned portions 33 in the crowned gear 10 according to this embodiment. Thus, upon engaging a plurality of mating gears (first and second driven gears 42, 43 in the above embodiment) with such a crowned gear 10, any of the mating gears can be engaged at middle positions of the respective crowned portions 33 by engaging the teeth of the plurality of mating gears with the respective crowned portions 33 of the crowned gear 10. Therefore, the crowned gear 10 can be engaged with any of the mating gears on the best condition, with the result that the indiscriminate and efficient transmission of the driving force to all the mating gears can be realized.

Further, each of the gear mechanisms 40, 40′ employing such a crowned gear 10 is provided with this crowned gear 10, and a plurality of mating gears (first and second driven gears 42, 43 in the above embodiments) engageable with the respective crowned portions 33 of the crowned teeth 30 of the crowned gear 10. Thus, the mutually engaged state is established between the crowned gear 10 and the plurality of mating gears engaged with the respective crowned portions 33 of the crowned gear 10, wherefore the driving rotation of one side about the central axis can be efficiently translated into the driven rotation of the other side about the central axes.

Since the crowned gear 10 is made of metal, the crowned portions 33 can be easily formed at the crowned teeth 30 using a machine tool for manufacturing gears such as a gear hobbing machine or a shaving machine. Contrary to this, the mating gears can be easily manufactured by an ordinary method such as injection molding in conformity with the crowned gear 10 since being made of synthetic resin.

Further, since the crowned gear 10 is so mounted on the drive shaft 411 of the drive motor 41 as to be concentric with and integrally rotatable with the drive shaft 411, the driving rotation of the crowned gear 10 by driving the drive motor 41 can be simultaneously transmitted to a plurality of driven gears made of synthetic resin by using the metallic crowned gear 10 as a drive gear. By employing the metallic crowned gear 10 as a drive gear to be simultaneously engaged with a plurality of driven gears in this way, a damage of the drive gear caused by abrasion or the like can be maximally suppressed.

The present invention is not limited to the foregoing embodiments and also embraces the following contents.

In the foregoing embodiments, the crowned gear 10 is used as a drive gear. Instead, the crowned gear 10 may be employed as a driven gear.

In the foregoing embodiments, the crowned gear 10 has a smaller diameter than the first and second driven gears 42, 43. Instead, the crowned gear 10 may have a larger diameter than the first and second driven gears 42, 43.

In the foregoing embodiments, the gear mechanisms 40, 40′ are described, taking those used in image forming apparatuses as examples. The present invention is not limited thereto and is applicable to various apparatuses.

In the foregoing embodiments are shown examples in which each of the crowned teeth 30 has two crowned portions 33. The number of the crowned portions 33 in each crowned tooth 30 is not limited to two, and three or more crowned portions 33 may be provided if necessary.

As described above, an inventive gear comprises a crowned portion formed by applying crowning to teeth, each tooth being formed with a plurality of crowned portions.

With such a construction, upon engaging a plurality of mating gears with the crowned gear in which each tooth is formed with a plurality of crowned portions, any of the mating gears can be engaged at middle positions of the respective crowned portions by engaging the teeth of the plurality of mating gears with the respective crowned portions of the crowned gear. Thus, the crowned gear can be engaged with any of the mating gears on the best condition. Therefore, the indiscriminate and efficient transmission of a driving force to all the mating gears can be realized.

An inventive gear mechanism uses the crowned gear having the above construction, and comprises the crowned gear and a plurality of mating gears engaged with the respective crowned portions of the teeth of the crowned gear, the crowned gear being made of metal and the mating gears being made of synthetic resin.

With such a construction, the mutually engaged state is established between the crowned gear and the plurality of mating gears engaged with the respective crowned portions of the crowned gear, wherefore the driving rotation of one side about a central axis/axes thereof can be efficiently translated into the driven rotation of the other about a central axis/axes.

Since the crowned gear is made of metal, the crowned portions can be easily formed at the teeth of the crowned gear by a cutting operation using a machine tool for manufacturing gears such as a gear hobbing machine or a shaving machine. Contrary to this, the mating gears can be easily manufactured by an ordinary method such as injection molding in conformity with the crowned gear since being made of synthetic resin.

The crowned gear may be preferably a drive gear mounted on a drive shaft of a specified drive motor in such a manner as to be concentric with and integrally rotatable with the drive shaft.

With such a construction, by using the metallic crowned gear as a drive gear, the driving rotation of the crowned gear given by driving the drive motor is simultaneously transmitted to the plurality of driven gears made of synthetic resin. By employing the metallic crowned gear as the drive gear simultaneously engaged with the plurality of driven gears in this way, a damage of a drive gear, which has a large load, caused by abrasion or the like can be maximally suppressed.

This application is based on patent application No. 2005-211841 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A gear, comprising:
a gear main body; and
a plurality of teeth projecting on the outer circumferential surface of the gear main body, each tooth including a plurality of crowned portions formed by arcuate bulges along a tooth trace direction.

2. A gear according to claim 1, wherein the crowned portions are provided at one and the other sides of a middle position with respect to the tooth trace direction.

3. A gear according to claim 1, wherein the formation pattern of the plurality of crowned portions is common to all the teeth.

4. A gear mechanism, comprising:
a first gear; and
a plurality of mating gears engageable with the first gear,
wherein the first gear includes:
a gear main body; and
a plurality of teeth projecting on the outer circumferential surface of the gear main body, each tooth having a plurality of crowned portions formed by arcuate bulges along a tooth trace direction.

5. A gear mechanism according to claim 4, wherein the first gear is made of metal and the mating gears are made of synthetic resin.

6. A gear mechanism according to claim 4, wherein:
the plurality of crowned portions include first crowned portions and second crowned portions provided at one and the other sides of a middle position with respect to the tooth trace direction, and
the plurality of mating gears include a second gear engageable with the first crowned portions and a third gear engageable with the second crowned portions.

7. A gear mechanism according to claim 4, wherein the first gear is a drive gear mounted on a drive shaft of a specified drive motor in such a manner as to be concentric with and integrally rotatable with the drive shaft.

8. A gear mechanism according to claim 6, wherein:
the first gear is a drive gear mounted on a drive shaft of a specified drive motor in such a manner as to be concentric with and integrally rotatable with the drive shaft, and
the second and third gears are driven gears having larger diameters than the first gear.

9. A gear mechanism according to claim 8, further comprising:
an idle arm whose operating direction is reversed depending on a rotating direction of the drive motor, and
an actuating gear for actuating the idle arm and engaged with the second or third gear.
